(19) United States
(12) Patent Application Publication
(10) Pub. No.: US 2015/0341284 A1
(43) Pub. Date: Nov. 26, 2015

(54) LINK ESTABLISHING METHOD ON MULTI-CORE FIBER, LINK ESTABLISHING DEVICE, AND LINK PARTNER DEVICE

(71) Applicant: ELECTRONICS AND TELECOMMUNICATIONS RESEARCH INSTITUTE, Daejeon (KR)

(72) Inventor: Tae Kyu KANG, Daejeon (KR)

(21) Appl. No.: 14/718,276

(22) Filed: May 21, 2015

(30) Foreign Application Priority Data
May 26, 2014 (CN) 10-2014-0062853

(51) Int. Cl. H04L 12/927; H04L 5/00

(52) U.S. Cl. CPC H04L 47/805; H04L 5/0055

(57) ABSTRACT

A link establishing method, a link establishing device and a link partner device are disclosed. A link establishing method performed by a link establishing device may include: exchanging link information on the link establishing device and link information on a link partner device through auto-negotiation messages; determining priority order of available links among a plurality of links connected between the link establishing device and the link partner device using the link information on the link establishing device and the link information on the link partner device; and establishing a link based on a multi-core fiber between the link establishing device and the link partner device on the basis of the priority order.

### CROSS-REFERENCE TO RELATED APPLICATION

This application claims the priority benefit of Korean Patent Application No. 10-2014-0062853, filed on May 26, 2014, in the Korean Intellectual Property Office, the disclosure of which is incorporated herein by reference.

### BACKGROUND

1. Field of the Invention

Embodiments of the present invention relate to a link establishing method between a link establishing device and a link partner device using an auto-negotiation message, a link establishing device and a link partner device.

2. Description of the Related Art

Ethernet employs different cables and connectors, and thus link establishments between devices are distinguished by used connectors. Here, a twisted-pair cable, such as an unshielded twisted pair (UTP), and RJ-45, which are used for link establishment in 10 megabits per second (Mbps) Ethernet, are also employed for 100 Mbps Ethernet, which brings about a compatibility issue. Accordingly, IEEE 802 has developed auto-negotiation technology independent of a transmission speed which automatically establishes a twisted-pair link using an RJ-45 connector in link initialization as part of 100 Mbps Ethernet standard, IEEE 802.3 Clause 28.

Ethernet provides physical interfaces, such as a copper interface transmitting an electric signal through a copper cable and a fiber interface transmitting an optical signal through a fiber cable. Here, electric signals have the same physical properties regardless of transmission speed and thus may use the same cable. However, optical signals have different physical properties depending on transmission speed and thus may not use the same cable.

Thus, auto-negotiation technology have been continuously advancing into a function of using a fast link pulse (FLP) operating at specific speed irrespective of transmission speed based on an Ethernet interface using a copper cable.

Auto-negotiation using a fiber interface has been developed exclusively for 1000BASE-X standards on 1 Gbps Ethernet, IEEE802.3 Clause 37. However, the fiber interface has changing physical properties on transmission speed. Thus, the fiber interface involves line-coding depending on transmission speed in data transmission. Accordingly, contents of transmission speed are excluded from exclusive auto-negotiation standards. That is, auto-negotiation technology is not adopted in a technique using a fiber interface.

A multi-core fiber provides at most hundreds of strands of fibers to a single cable using a multiple-fiber push-on/pull-off (MPO) cable and a ribbon connector. A user may achieve structural simplicity and cost reduction by using the multi-core fiber.

### SUMMARY

According to an aspect of the present invention, there is provided a link establishing method performed by a link establishing device, the method including exchanging link information on the link establishing device and link information on a link partner device through auto-negotiation messages; determining priority order of available links among a plurality of links connected between the link establishing device and the link partner device using the link information on the link establishing device and the link information on the link partner device; and establishing a link based on a multi-core fiber between the link establishing device and the link partner device on the basis of the priority order.

The determining of the priority order may determine the priority order of the available links among the plurality of links connected between the link establishing device and the link partner device using connection mode information on links included in the link information on the link establishing device and the link information on the link partner device.

The determining of the priority order may determine the priority order of the available links among the plurality of links connected between the link establishing device and the link partner device using transmission speed information on links included in the link information on the link establishing device and the link information on the link partner device.

The exchanging of the link information may include detecting a base page from an auto-negotiation message of the link partner device; and identifying the link information on the link partner device in the detected base page.

The exchanging of the link information may include transmitting an auto-negotiation message of the link establishing device including a first acknowledgement (ACK) bit a preset number of times from the link establishing device to the link partner device; receiving an auto-negotiation message of the link partner device including the first ACK bit from the link partner device a preset number of times; transmitting an auto-negotiation message of the link establishing device including a second ACK bit a preset number of times from the link establishing device to the link partner device in response to reception of the auto-negotiation message from the link partner device; and receiving an auto-negotiation message of the link partner device including the second ACK bit from the link partner device a preset number of times.

The detecting may include determining whether first ACK bits included in one or more auto-negotiation messages received from the link partner device are the same; determining whether base page fields included in the one or more auto-negotiation messages received from the link partner device are the same; and determining whether the base page fields included in the auto-negotiation messages of the link partner device including the first ACK bits are the same as base page fields included in auto-negotiation messages of the link partner device including second ACK bits.

The exchanging of the link information may include detecting a next page field included in an auto-negotiation message of the link partner device; and identifying information transmitted by at least one of the link partner device and a service in the detected next page field.

The base page may include at least one of connection mode information, flow control information, error information and acknowledgement information provided by the link partner device.

The determining of the priority order may determine the priority order of the available links among the plurality of links connected between the link establishing device and the link partner device using link information included in a base page in an auto-negotiation message of the link partner device and the link information on the link establishing device.

The establishing of the link may establish a link between a first link establishing device and a second link establishing device by controlling the multi-core fiber according to the priority order.

According to another aspect of the present invention, there is provided a link establishing apparatus performing a link establishing method, the apparatus including an exchange unit to exchange link information on the link establishing device and link information on a link partner device through auto-negotiation messages; a priority order determination unit to determine priority order of available links among a plurality of links connected between the link establishing device and the link partner device using the link information on the link establishing device and the link information on the link partner device; and a link establishment unit to establish a link based on a multi-core fiber between the link establishing device and the link partner device on the basis of the priority order.

The priority order determination unit may determine the priority order of the available links among the plurality of links connected between the link establishing device and the link partner device using connection mode information on links included in the link information on the link establishing device and the link information on the link partner device.

The priority order determination unit may determine the priority order of the available links among the plurality of links connected between the link establishing device and the link partner device using transmission speed information on links included in the link information on the link establishing device and the link information on the link partner device.

The exchange unit may detect a base page from an auto-negotiation message of the link partner device and identify the link information on the link partner device in the detected base page.

The exchange unit may transmit an auto-negotiation message of the link establishing device including a first ACK bit a preset number of times from the link establishing device to the link partner device, receive an auto-negotiation message of the link partner device including the first ACK bit from the link partner device a preset number of times, transmit an auto-negotiation message of the link establishing device including a second ACK bit a preset number of times from the link establishing device to the link partner device in response to reception of the auto-negotiation message from the link partner device, and receive an auto-negotiation message of the link partner device including the second ACK bit from the link partner device a preset number of times.

The exchange unit may determine whether first ACK bits included in one or more auto-negotiation messages received from the link partner device are the same, determine whether base page fields included in the one or more auto-negotiation messages received from the link partner device are the same, and determine whether the base page fields included in the auto-negotiation messages of the link partner device including the first ACK bits are the same as base page fields included in auto-negotiation messages of the link partner device including second ACK bits.

The exchange unit may detect a next page field included in an auto-negotiation message of the link partner device, and identify information transmitted by at least one of the link partner device and a service in the detected next page field.

The base page may include at least one of connection mode information, flow control information, error information and acknowledgement information provided by the link partner device.

The priority order determination unit may determine the priority order of the available links among the plurality of links connected between the link establishing device and the link partner device using link information included in a base page in an auto-negotiation message of the link partner device and the link information on the link establishing device.

The link establishment unit may establish a link between a first link establishing device and a second link establishing device by controlling the multi-core fiber according to the priority order.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates relationship between a link establishing device and a link partner device according to an embodiment;

FIG. 2 illustrates a link establishing method through link information exchanges between devices according to an embodiment;

FIGS. 3A to 3D illustrate a link establishing device and a link partner device providing multirate Ethernet via a multi-core fiber according to an embodiment;

FIG. 4 illustrates a structure of an Ethernet layer with an auto-negotiation function added according to an embodiment;

FIG. 5 illustrates a process of transmitting an auto-negotiation message according to an embodiment;

FIG. 6 illustrates a structure of an auto-negotiation message according to an embodiment;

FIG. 7 illustrates an auto-negotiation structure in a link establishing device according to an embodiment; and

FIG. 8 illustrates a link establishing device conducting a link establishing method through link information exchanges between devices according to an embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

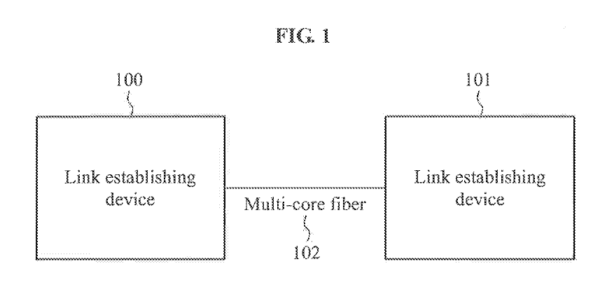

FIG. 1 illustrates relationship between a link establishing device and a link partner device according to an embodiment.

Referring to FIG. 1, the link establishing device 100 may be connected to the link partner device 101 through a multi-core fiber 102. In detail, the link establishing device 100 may convert data into an optical signal to transmit to the link partner device 101 through the multi-core fiber 102. Likewise, the line partner device 10 may convert data into an optical signal to transmit to the link establishing device 100 through the multi-core fiber 102. That is, the link establishing device 100 and the link partner device 101 may be partner devices connected to each other via a link as link counterparts.

For instance, the link establishing device 100 may correspond to a first link establishing device, and the link partner device 101 may correspond to a second link establishing device. Alternatively, the link partner device 101 may correspond to another link establishing device as a link partner of the link establishing device 100.

Here, the multi-core fiber 102 may include a multi-fiber push-on/pull-off (MPO) cable, a ribbon connector, and N single fibers, and accordingly the link establishing device 100 may set up a line to use through line coding and transmit data at different speeds.

The link establishing device 100 and the link partner device 101 may transmit auto-negotiation messages to each other via the multi-core fiber 102 to exchange link information. Then, the link establishing device 100 may determine priority order of links between the link establishing device 100 and the link partner device 101 using link information on the link establishing device 100 and link information on the link partner device 101.

In response, the link partner device 101 may determine priority order of the links between the link establishing device 100 and the link partner device 101 using the link information on the link establishing device 100 and the link information on the link partner device 101. The link establishing device 100 and the link partner device 101 determine the priority orders using the same information, and thus the determined orders are the same. Accordingly, links established respectively by the link establishing device 100 and the link partner device 101 based on the respective priority orders may be the same. The link establishing device 100 and the link partner device 101 may transmit and receive data through the same link.

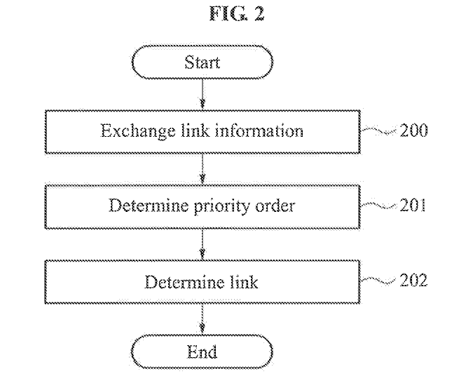

FIG. 2 illustrates a link establishing method through link information exchanges between devices according to an embodiment.

Referring to FIG. 2, in operation 200, a link establishing device may exchange link information on the link establishing device with link information on the link partner device through auto-negotiation messages. Here, the link establishing device and the link partner device may be link partners connected to each other via a link.

For instance, the link establishing device may correspond to a first link establishing device, and the link partner device may correspond to a second link establishing device. Alternatively, the link partner device may be another link establishing device as a link partner of the link establishing device. The auto-negotiation messages may include at least one of connection mode (transmission speed) information provided possibly via a multi-core fiber, flow control information provided possibly through media access control (MAC), link error information and acknowledgement (ACK) information.

For example, the link establishing device may detect a base page from an auto-negotiation message of the link partner device. The link establishing device may identify the link information on the link partner device on the detected base page to recognize the link information on the link partner device.

The base page may include, for example, an ACK bit for detecting an error. Accordingly, the link establishing device may transmit a preset number of auto-negotiation messages to compare ACK bits included in the transmitted auto-negotiation messages.

For example, the link establishing device may transmit an auto-negotiation message of the link establishing device including a first ACK bit to the link partner device a preset number of times. The link establishing device may receive an auto-negotiation message of the link partner device including the first ACK bit from the link partner device a preset number of times.

Subsequently, the link establishing device may transmit an auto-negotiation message of the link establishing device including a second ACK bit to the link partner device a preset number of times. The link establishing device may receive an auto-negotiation message of the link partner device including the second ACK bit from the link partner device a preset number of times. Accordingly, the link establishing device may conduct a matching test of the auto-negotiation messages using the ACK bits included in the auto-negotiation messages of the link partner device and base page fields included in the auto-negotiation messages of the link partner device.

The base page fields may refer to a field storing the link information on the link partner device. In detail, the link establishing device may conduct an M-stage matching test to secure reliability of the link information on the link partner device. For example, the link establishing device may determine whether first ACK bits included in one or more auto-negotiation messages received from the link partner device are the same. Also, the link establishing device may determine whether base page fields included in one or more auto-negotiation messages received from the link partner device are the same.

Furthermore, the link establishing device may determine whether a base page field included in the auto-negotiation message of the link partner device including the first ACK bit is the same as a base page field included in the auto-negotiation message of the link partner device including the second ACK bit. In response, the link partner device may conduct a matching test of the auto-negotiation messages using the auto-negotiation messages transmitted by the link establishing device. That is, the link establishing device may receive the link information on the link partner device through exchanges of the auto-negotiation messages.

In operation 201, the link establishing device may determine priority order of available links among a plurality of links connected between the link establishing device and the link partner device using the link information on the link establishing device and the link information on the link partner device. For example, the link establishing device may detect the link information on the second link establishing using the base page included in the auto-negotiation message received from the link partner device. Accordingly, the link establishing device may determine the priority order of the links using the link information on the link establishing device and the link information on the link partner device.

For instance, the link establishing device may determine the priority order for link establishment using connection mode information on links included in the link information on the link establishing device and the link information on the link partner device. Here, the connection mode information may include transmission speed information. In detail, the link establishing device may combine MPO cables and single cables included in the multi-core fiber using an MPO fan-out cord in various ways. Accordingly, the link establishing device may set up diverse connection modes and change a transmission speed by setting up a different connection mode. The link establishing device may determine the priority order in order of connection modes with a higher transmission speed, available between the link establishing device and the link partner device, using the link information on the link establishing device and the link information on the link partner device, and establish a link based on the determined priority order.

For example, the link establishing device may determine the priority order according to transmission speed using transmission speed information on links included in the link information on the link establishing device and the link information on the link partner device. In detail, the link establishing device may determine the priority order of the available links in order of higher transmission speed using the link information on the link establishing device and the link information on the link partner device.

When the priority order is determined according to transmission speed, the link establishing device may the priority order for link establishment using flow control information on links included in the link information on the link establishing device and the link information on the link partner device. Here, flow control may refer to control of transmission and reception via a link. In detail, when a transmission speed of a link established between the link establishing device and the link partner device is higher than a processing speed of the link establishing device or link partner device, the link establishing device and the link partner device may delete data received through the link. Thus, the link establishing device may determine the priority order for flow control of links between the link establishing device and the link partner device to control transmission and reception via the links, thus preventing deletion of data. Here, criteria for determining the priority order for the flow control may be set up by a system administrator or a user.

The link establishing device may recognize error occurrence in a link using error information included in the link information received from the link partner device. On the contrary, the link partner device may recognize error occurrence in a link using error information included in the link information received from the link establishing device. For example, the base page included in the auto-negotiation message received by the link establishing device may include a radio frequency (RF) bit with input error information on the link establishing device. Accordingly, the link establishing device may recognize the error information through the RF bit.

In operation 202, the link establishing device may establish a link based on the multi-core fiber between the link establishing device and the link partner device according to the determined priority order. That is, the link establishing device and the link partner device may receive the auto-negotiation messages, respectively, and compare own link information with counterpart link information, thereby determining the priority order. Accordingly, the link establishing device and the link partner device may determine the priority orders, respectively, and establish the link between the link establishing device and the link partner device based on the determined priority orders.

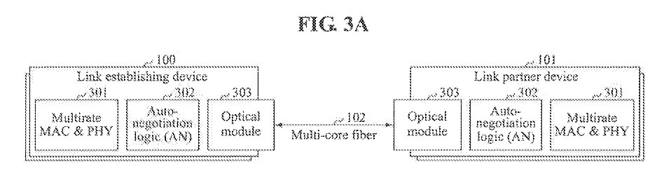

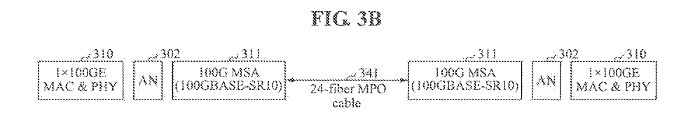

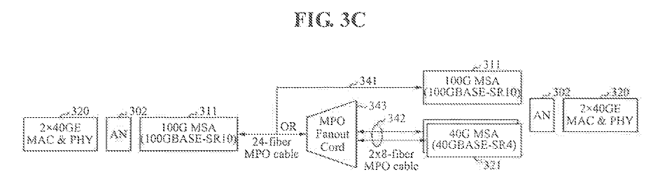

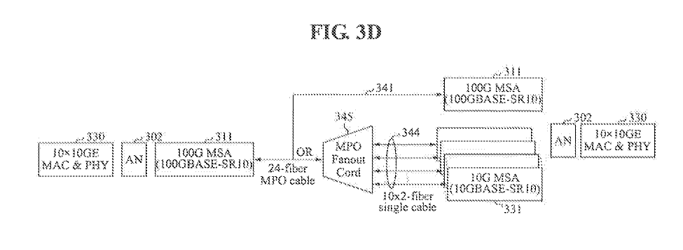

FIGS. 3A to 3D illustrate a link establishing device and a link partner device providing multirate Ethernet via a multi-core fiber according to an embodiment.

Referring to FIG. 3A, the link establishing device 100 and the link partner device 101 may be connected via the multi-core fiber 102. Here, the link establishing device 100 may include an optical module 303, an auto-negotiation (auto-nego) logic 302, and a multirate MAC & PHYsical (PHY) 301. The link partner device 101 may include an optical module 303, an auto-negotiation logic 302, and a multirate MAC & PHY 301.

For example, the optical module 303 may convert an electric signal into an optical signal to transmit data through the multi-core fiber 102. Further, the optical module 303 may convert data transmitted through the multi-core fiber 102 into an electric signal. The auto-negotiation logic 302 may set up priority order of links between the link establishing device 100 and the link partner device 101 using link information obtained by auto-negotiation message exchanges. The multirate MAC & PHY 301 may transmit and receive an Ethernet frame using a transmission medium. For example, to transmit an optical signal, the transmission medium may be the multi-core fiber cable 102.

The multi-core fiber cable 102 may include an MPO cable 341 and a single cable 344. Further, referring to FIGS. 3A to 3D, the MPO cable 341 and the single cable 344 may be configured in various combinations through MPO fan-out cords 343 and 345.

The optical module 303 may employ a 10 G transponder 311, a 40 G transponder 321 and a 100 G MSA transponder 331, wherein 40 G/100G MSAs are based on the multi-core fiber. The auto-negotiation logic 302 may be automatically connected to a 100 Gigabit Ethernet (GE) MSA 311, a 1000 MSA 311, a 2×40 G MSA 321 or a 10×10 G MSA 331 based on the priority order determined through the auto-negotiation messages. The multirate MAC & PHY 301 may provide a multi-rate of 10×10 GE, 2×40 GE or 100 GE.

The link establishing device 100 and the link partner device 101 may provide various connection modes. Here, the multi-core fiber cable 102 may use a 24-fiber MPO cable 341. Also, the multi-core fiber cable 102 may be converted into a 24-fiber MPO to 2×8-fiber MPO 342 or 24-fiber MPO to 10×2-fiber single 344 using the MPO fan-out cords 343 and 345.

Referring to FIG. 3B, the link establishing device 100 and the link partner device 101 may operate in 1×100 GE mode. Here, the multirate MAC & PHYs 301 of the link establishing device 100 and the link partner device 101 may operate by 1×100 GE 310. Further, the link establishing device 100 and the link partner device 101 may connect to each other through the 100 G MSA 311 and the 24-fiber MPO cable 341.

Referring to FIG. 3C, the link establishing device 100 and the link partner deice 101 may operate in 2×40 GE mode. Here, the multirate MAC & PHYs 320 of the link establishing device 100 and the link partner device 101 may operate by 2×40GE.

In addition, the link establishing device 100 and the link partner device 101 may connect to each other through the 100 G MSA 311 and the 24-fiber MPO cable 341. Here, the link establishing device 100 may use the 100 G MSA 311 and the 24-fiber MPO cable 341. The link partner device 101 may use two 40 G MSAs 321 and two 8-fiber MPO cables 342. The link establishing device 100 and the link partner device 101 may be also connected through the MPO fan-out cord 343.

Referring to FIG. 3D, the link establishing device 100 and the link partner device 101 may operate in 10×10 GE mode. Here, the multirate MAC & PHYs 302 of the link establishing device 100 and the link partner device 101 may operate by 10×10 GE. The link establishing device 100 may use the 100 G MSA 311 and the 24-fiber MPO cable 341. The link partner device 101 may use ten 10 G MSAs 331 and ten 2-fiber single cables 344. The link establishing device 100 and the link partner device 101 may connect to each other through the MPO fan-out cord 345.

That is, when the 1000 MSA 311 and the 24-fiber MPO cable 341 are used, the link establishing device 100 and the link partner device 101 may provide 1×100 GE, 2×40 GE or 10×10 GE connections through the link establishing method.

Further, when the 40 G MSA and the 10G MSA 321 and 331 are distributed in two or more devices, the link establishing device 100 and the link partner device 101 may connect to each other by user manual setup.

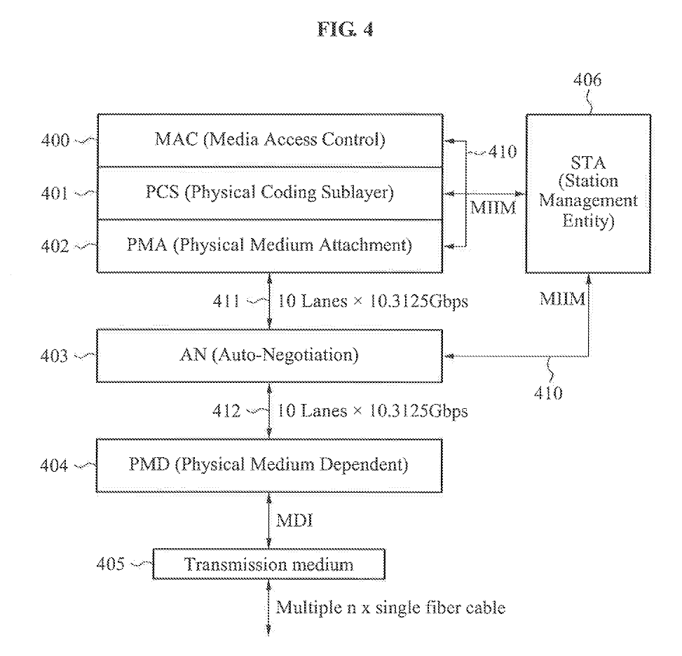

FIG. 4 illustrates a structure of an Ethernet layer with an auto-negotiation function added according to an embodiment.

Referring to FIG. 4, the multirate MAC & PI-IY 301 of FIG. 3 may correspond to a Media Access Control (MAC) 400, a Physical Coding Sublayer (PCS) 401 and a Physical Medium Attachment (PMA) 402. Further, the auto-negotiation logic 302 of FIG. 3 may correspond to an Auto-Negotiation (AN) 403. The optical module may correspond to a Physical Medium Dependent (PMD) 404. The multi-core fiber cable of FIG. 3 may correspond to a transmission medium 405.

Referring to FIG. 4, the structure of the Ethernet layer based on a multi-core fiber may be divided into a Media Access Control (MAC) layer 400, physical (PHY) layers 401 to 404, and a Station Management Entity (STA) 406.

The MAC layer 400 may conduct Ethernet framing. The PHY layers 401 to 404 may conduct transmission and reception of an Ethernet frame through the transmission medium 405. The STA 406 may be a management entity which collects status information on the MAC layer 400 or the PHY layer 404 or transmit control information. For example, the STA 406 may receive link information with priority order determined by the AN 403 through a Media Independent Interface Management (MIIM) 410 to transmit to the MAC layer 400. The MAC layer 400 may establish a link based on the priority order.

The PHY layers 401 and 404 may include the PCS 401, the PMA 402, the AN 403, and the PMD 404.

The PCS 401 may conduct line coding based on transmission characteristics of the transmission medium. For example, a 40 GE PCS and a 100 GE PCS may use the same 64B/66B code as used for a 10 GE PCS (xGBASE-R PMA is used, x=10/40/100).

The PMA 402 may conduct serialization of encoded parallel bus signals and deserialization of serial bit signals (xGBASE-R PMA is used, x=10/40/100).

The AN 403 may exchange link information between the link establishing device and the link partner device through an auto-negotiation message encoded via 64B/66B used for the 10 GE PCS, the 40 GE PCS and the 100 GE PCS, thereby automatically establishing various links with different transmission speeds of 10 GE, 40 GE or 100 GE.

Here, the link establishing device and the link partner device may exchange auto-negotiation messages through a first lane among 10 lanes×10.3125 Gbps interfaces 412 between the AN 403 and the PMD 404. The 10 lanes×10.3125 Gbps interfaces may accommodate a 100 Gigabit Attachment Unit Interface (CAUI) at 100 GE. Further, the 10 lanes×10.3125 Gbps interfaces may accommodate a 40 Gigabit Attachment Unit Interface (2×XLAUI) at 40 GE. The 10 lanes×10.3125 Gbps interfaces may accommodate a 10 Gigabit Framer Interface (10× XFI) at 10 GE.

The PMD 404 may conduct conversion between an electric signal and an optical signal (xGBASE-SR PMD is used, x=10/40/100).

The transmission medium 405 may include fiber, copper, or the like. For example, a 10GBASE-SR PMD may connect a 2-fiber single cable, and a 40GBASE-SR4 PMD may connect an 8-fiber MPO cable. A 100GBASE-SR10 PMD may connect a 24-fiber MPO cable.

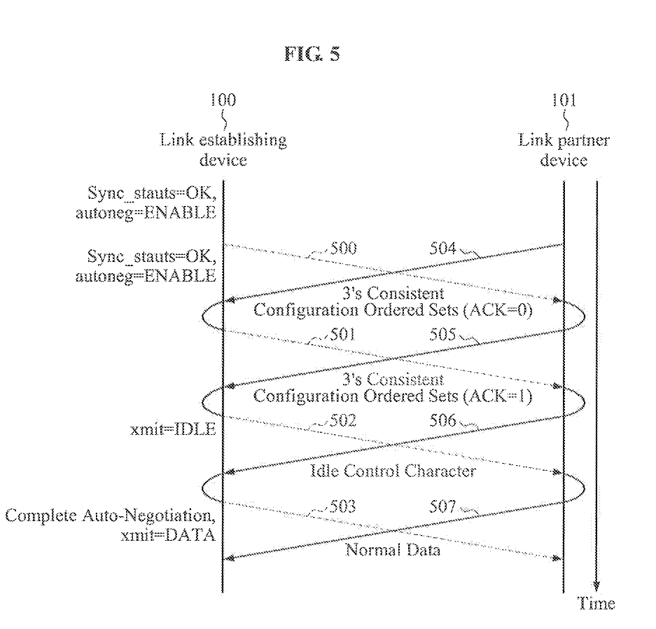

FIG. 5 illustrates a process of transmitting an auto-negotiation message according to an embodiment.

A link establishing device 100 and a link partner device 101 may exchange link information on the link establishing device 100 and link information on the link partner device 101 through auto-negotiation messages.

Here, a configuration ordered set may refer to encoded data on the link information on the link establishing device 100 or the link information on the link partner device 101.

An auto-negotiation message may be, for example, encoded into 66 bits using 64B/66B mutually used for 10 GE, 40 GE and 100 GE PCSes.

A link establishing process through auto-negotiation message exchanges may be carried out according to a procedure defined in an operational diagram of the gigabit Ethernet 1000BASE-X standard (IEEE 802.3 Clause 37, Auto-Negotiation function, type 1000BASE-X).

The link establishing device 100 and the link partner device 101 may be set to automatically exchange auto-negotiation messages. Also, the link establishing device 100 and the link partner device 101 may exchange auto-negotiation messages based on a user definition. When at least one of the two devices is initialized, the link establishing device 100 and the link partner device 101 may check states thereof and exchange auto-negotiation messages.

Referring to FIG. 5, the link establishing device 100 may transmit a 64B/66B-encoded idle control code for a predetermined period of time, for example, 1 millisecond (ms) or longer. The link establishing device 100 may acquire a block synchronization (sync) for interpreting a received 64B/66B code group (sync_status=OK).

When an auto-negotiation function is enabled (autoneg=ENABLE), the link establishing device 100 may set a transmission mode to a configuration mode (xmit=CONFIGURATION) to transmit an auto-negotiation message.

Accordingly, the link establishing device 100 and the link partner device 101 may transmit auto-negotiation messages including own link information thereof to exchange the link information.

For example, the link establishing device 100 may encode an auto-negotiation message using 64B/66B to transmit to the link partner device 101. Here, a configuration ordered set of the auto-negotiation message may set an ACK bit to 0. Accordingly, the link establishing device 100 may transmit the auto-negotiation message with the ACK bit set to 0 to the link partner device 101 a preset number of times.

Referring to FIG. 5, the link establishing device 100 may transmit a configuration ordered set 500 with an ACK bit set to 0 to the link partner device 101 three times. In response, the link partner device 101 may transmit a configuration ordered set 504 with an ACK bit set to 0 to the link establishing device 100 three times.

When the configuration ordered set 504 of the link partner device 101 with the ACK bit set to 0 is received, the link establishing device 100 may transmit a configuration ordered set 501 with an ACK bit set to 1 three times. In response, when the configured ordered set 501 of the link establishing device 100 with the ACK bit set to 0 is received, the link partner device 101 may transmit a configuration ordered set 505 with an ACK bit set to 1 three times.

When an auto-negotiation message with an ACK bit set to 1 is received three times from the link partner device 101, the link establishing device 100 may stand by for a predetermined period of time, for example, 1 ms or longer, and set the transmission mode to an idle mode (xmit=IDLE). Then, the link establishing device 100 may transmit an idle control code 502 for a predetermined period of time, for example, 1 ms or longer. In response, the link partner device 101 may transmit an idle control code 506 for a predetermined period of time, for example, 1 ms or longer.

The link establishing device 100 may compare the link information in the configuration ordered set received from the link partner device 101 with the link information on the link establishing device 100 and determine priority order of available links among a plurality of links connected between the link establishing device 100 and the link partner device 101 according to predetermined criteria. The link establishing device 100 may transmit the determined priority order to an STA and set an operation mode to a data mode, for example, xmit=DATA.

In response, the link partner device 101 may compare the link information in the configuration ordered set received from the link establishing device 100 with the link information on the link partner device 101 and determine priority order of available links among a plurality of links connected between the link establishing device and the link partner device according to predetermined criteria. The link partner device 101 may transmit the determined priority order to the STA and set an operation mode to a data mode, for example, xmit=DATA.

Accordingly, the link establishing device 100 may transmit data 503 to the link partner device 101 using a link established based on the priority order. Likewise, the link partner device 101 may transmit data 507 to the link establishing device 100 using a link established based on the priority order.

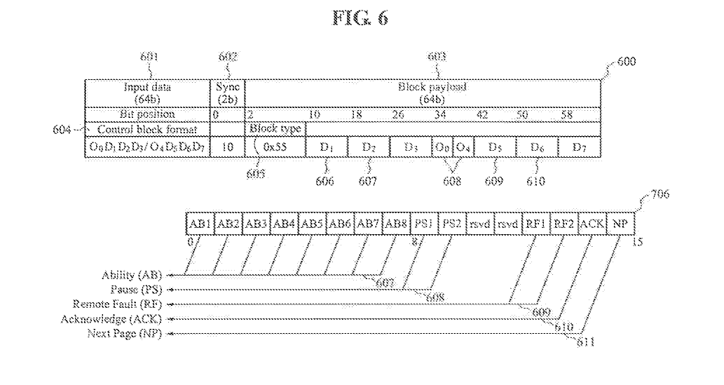

FIG. 6 illustrates a structure of an auto-negotiation message according to an embodiment.

Referring to FIG. 6, the auto-negotiation message may include link information on a link establishing device or link information on a link partner device. The auto-negotiation message may also include necessary information for link establishment or exchange of the auto-negotiation message.

The link establishing device and the link partner device may transmit auto-negotiation messages through a multi-core fiber cable. Thus, the auto-negotiation messages may be encoded and transmitted according to a transmission medium.

Referring to FIG. 6, the auto-negotiation messages may be encoded into 66 bits using 64B/66B to be transmitted. That is, the link establishing device may encode the auto-negotiation messages into a 66-bit block including a data code or control code that is 64-bit input data 601, a sync header 602 and a block payload 603. Here, the link establishing device may input 0b′01 into the synch header 602 of the data code. Also, the link establishing device may input 0b′10 into the synch header 602 of the control code.

For instance, the link establishing device may transmit an auto-negotiation message, with 0b′00 or 0b′11 input into the synch header 602, to transmit to the link partner device. When the auto-negotiation message is received, the link partner device may determine the auto-negotiation message received from the link establishing device as an error message.

A control code 605 may include control or defect state information on an Ethernet frame. For example, the control code 605 may include at least one of start, end, error, local fault state and remote fault state of an Ethernet frame. The block payload 603 of the control code may set a block type 605 to define a block format. For example, the link establishing device may input 0x55 into the block type 605 to define a block format. The link establishing device may input 0x1 into Control Character (O0, O4) 608.

Here, an auto-negotiation base page field may include D1 606 and D2 607. An auto-negotiation base page may include information on a link connected to the link establishing device or the link partner device.

In detail, D2 may refer to an Ability (AB) bit and include information on any connection mode possibly provided via the multi-core fiber. The AB bit may include information as follows: AB1=4×10GBASE-SR (10GE), AB2=10×IOGBASE-SR (10GE), AB3=1×40GBASE-SR4 (400E), AB4=2×40GBASE-SR4 (40GE), ABS=1×100GBASE-SR10 (1000E), and AB6˜ABS=Reserved.

That is, the link establishing device may use connection modes included in AB1 to AB5. Here, priority order of the connection modes may correspond to AB5 (Highest)>AB4>AB3>AB2>AB1 (Lowest).

Further, the link establishing device and the link partner device may establish a link between the link establishing device and the link partner device based on the AB bit as follows: 4×10GBASE-SR=4×10GBASE-SR, 10×10GBASE-SR=10×10GBASE-SR, 1×40GBASE-SR4=1×40GBASE-SR4, 1×100GBASE-SR10=1×100GBASE-SR10, 1×40GBASE-SR4=4×10GBASE-SR (here, MAC/PHY=operate in 4×10GBASE-SR), 1×100GBASE-SR4=10×10GBASE-SR(here, MAC/PHY=operate in 10×10GBASE-SR), and 1×100GBASE-SR4=2×40GBASE-SR(here, MAC/PHY=operate in 2×40GBASE-sR).

A Pause (PS) bit may include information on flow control possibly provided by the MAC. Here, the flow control possibly provided by the MAC may be divided into a symmetric mode supporting pause transmission and reception and an asymmetric mode supporting either of transmission and reception.

A Remote Fault (RF) bit may include error information. For instance, the RF bit may include error information, such as remote fault state. A Next Page (NP) bit may include data input separately by an administrator or specific application. The link establishing device and the link partner device may exchange information, other than the link information included in the base page, using the NP bit.

The administrator may set up a process for setting definitions of fields and for determining priority order, thereby establishing a link between the link establishing device and the link partner device. For example, the administrator may set up a process for determining definitions of fields, except for ABL, and priority order based on the 1000BASE-X auto-negotiation function (Clause 37), thereby establishing the link between the link establishing device and the link partner device.

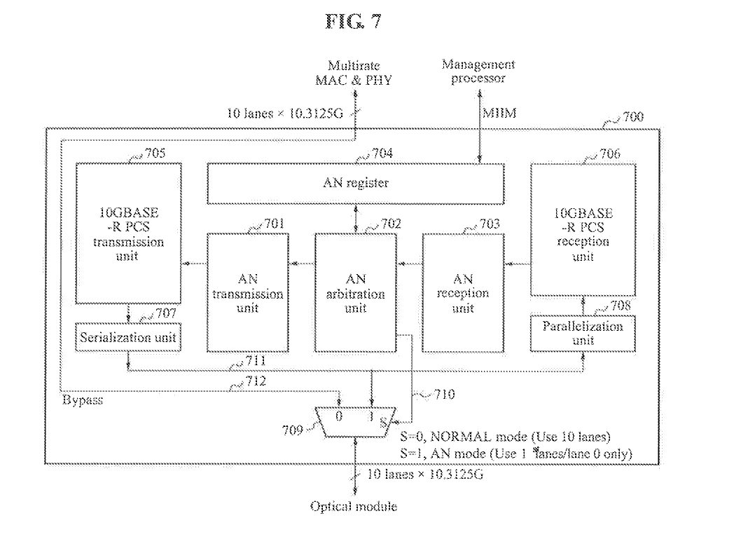

FIG. 7 illustrates an auto-negotiation block in a link establishing device according to an embodiment.

The AN of FIG. 3 may correspond to an auto-negotiation structure illustrated in FIG. 7. That is, FIG. 7 illustrates an embodiment of the AN of FIG. 3.

Referring to FIG. 7, the auto-negotiation block may include an auto-negotiation transmission unit 701, an auto-negotiation reception unit 703, an auto-negotiation arbitration unit 702, an auto-negotiation register 704, a 10GBASE-R PCS transmission unit 705, a 10GBASE-R PCS reception unit 706, a serialization unit 707, a parallelization unit 708, and a path selector 709.

For example, the auto-negotiation transmission unit 701 may input link information expressed with 8 bytes into a configuration ordered set to transmit to the 10GBASE-R PCS transmission unit 705.

Here, an auto-negotiation base page field in the configuration ordered set may input information stored in the auto-negotiation register 704 through the auto-negotiation arbitration unit 702.

That is, the link establishing device may store link information on the link establishing device in the auto-negotiation register 704. When transmission of an auto-negotiation message is requested for link establishment, the link establishing device may transmit the link information stored in the auto-negotiation register 704 to the auto-negotiation transmission unit 701. The auto-negotiation transmission unit 701 may input the link information included in the auto-negotiation base page field in the configuration ordered set to transmit to the 10GBASE-R PCS transmission unit 705.

The auto-negotiation reception unit 703 may receive an auto-negotiation message through the 10GBASE-R PCS reception unit 706. The auto-negotiation reception unit 703 may detect an auto-negotiation base page field of the link partner device included in the auto-negotiation message and store detected link information in the auto-negotiation register 704 through the auto-negotiation arbitration unit 702.

The auto-negotiation block may identify link information by detecting an auto-negotiation base page field. Here, a base field of an auto-negotiation message may detected by identifying whether an ACK bit included in the auto-negotiation message received from the link partner device is matched with a base page included in the auto-negotiation message.

For example, the auto-negotiation block may detect a base page through a three-stage matching test.

First, the auto-negotiation block may identify whether ACK bits included in auto-negotiation base page fields of one or more auto-negotiation messages received from the link partner device are the same.

For instance, the link partner device may transmit an auto-negotiation message as an optical signal three times. Here, the optical module may convert the auto-negotiation messages into an electric signal to transmit to the auto-negotiation reception unit 703. Accordingly, the auto-negotiation arbitration unit 702 may determine whether ACK bits includes in the three auto-negotiation messages are the same. When the three ACK bits are the same, the auto-negotiation arbitration unit 702 may conduct the following stage of the matching test.

Secondly, the auto-negotiation block may identify whether base page fields of the auto-negotiation messages with the same ACK bits are the same. For example, when the link partner device transmits an auto-negotiation message three times, the auto-negotiation arbitration unit 702 may conduct a matching test of base page fields included in the received three auto-negotiation messages.

Thirdly, the link partner device may receive an auto-negotiation message from the link establishing device a preset number of times. In response, the link partner device may transmit an auto-negotiation message with a changed ACK bit a preset number of times. Then, the auto-negotiation block may conduct a matching test of base page fields of the auto-negotiation messages with different ACK bits.

When the matching test is properly finished, the auto-negotiation arbitration unit 702 may transmit base page field information to the auto-negotiation register 704. The auto-negotiation register 704 may store the received base page field information.

The auto-negotiation register 704 may store the link information on the link establishing device as a base page field. Thus, the auto-negotiation transmission unit 701 may receive the base page field of the link establishing device from the auto-negotiation register 704 and transmit the auto-negotiation message.

That is, the auto-negotiation arbitration unit 702 may determine priority order of links between the link establishing device and the link partner device using the base page field information on the link establishing device transmitted from the auto-negotiation register 704 and base page field information on the link partner device.

The auto-negotiation arbitration unit 702 may transmit information on the priority order to the auto-negotiation register 704. The auto-negotiation register 704 may store the information on the priority order.

The auto-negotiation register 704 may control link establishment through an external management processor, for example, by enabling or restarting auto-negotiation, or provide status information related to link establishment, for example, the link information on the link partner device, whether auto-negotiation is completed and a priority order determination result.

The 10GBASE-R PCS transmission unit 705 may encode 8-byte (64-bit) control block data, corresponding to the configuration ordered set received from the auto-negotiation transmission unit 701, into 66 bits. Further, the 10GBASE-R PCS transmission unit 705 may randomize the 8-byte (64-bit) control block data into a signal pattern strong on a characteristic of a transmission line through scrambling, convert the signal pattern into a 16-bit unit bus signal and transmit the signal to the serialization unit 707.

The 10GBASE-R PCS reception unit 706 may reconstruct the 16-bit unit bus signal, received from the parallelization unit 708, into an original signal. In detail, the 10GBASE-R PCS reception unit 706 may conduct descrambling and decoding. Accordingly, the 10GBASE-R PCS reception unit 706 may transmit the 8-byte control block data including the link information on the link partner device to the auto-negotiation reception unit 703. Additionally, the 10GBASE-R PCS reception unit 706 may transmit a 66B block sync state to the auto-negotiation reception unit 703 through sync header identification.

The serialization unit 707 may convert the 16-bit bus signal, transmitted from the 10GBASE-R PCS transmission unit 705, into a 1-bit serial signal of 10.3125 Gbps to transmit to the path selector 709.

The parallelization unit 708 may transmit the 16-bit bus signal, obtained by reconstructing a clock and data from the 10.3125 Gbps serial signal received through the path selector 709, to the 10GBASE-R PCS reception unit 706.

When no link is established according to auto-negotiation between the link establishing device and the link partner device, the auto-negotiation arbitration unit 702 may set a control bit (selector: S) 710 of the path selector 709 to 1 to control a path so that the auto-negotiation function block processes data.

When a link is established according to auto-negotiation between the link establishing device and the link partner device, the auto-negotiation arbitration unit 702 may set the control bit of the path selector 709 to 0 to control the path so that a multirate MAC/PHY processes data.

For example, auto-negotiation data 711 may exchange an auto-negotiation message using a first lane among 10.3125 Gbps interfaces of 10 lanes.

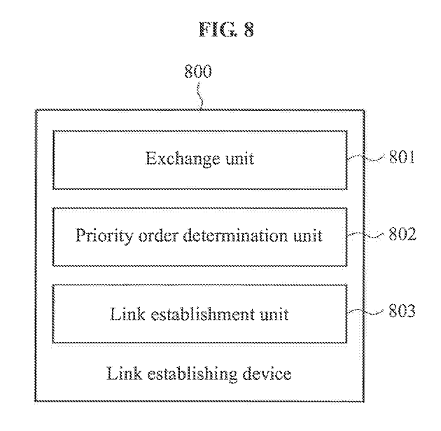

FIG. 8 illustrates a link establishing device conducting a link establishing method through link information exchanges between devices according to an embodiment.

Referring to FIG. 8, an exchange unit 801 may exchange link information on the link establishing device 800 with link information on a link partner device through auto-negotiation messages. Here, the link establishing device 800 and the link partner device may be link partners connected to each other via a link. For instance, the link establishing device 800 may correspond to a first link establishing device, and the link partner device may correspond to a second link establishing device. Alternatively, the link partner device may be another link establishing device as a link partner of the link establishing device 800.

The auto-negotiation messages may include at least one of connection mode (transmission speed) information provided possibly via a multi-core fiber, flow control information provided possibly through MAC, link error information and ACK information. The exchange unit 801 may detect a base page from an auto-negotiation message of the link partner device. The exchange unit 801 may identify the link information on the link partner device on the detected base page to recognize the link information on the link partner device.

The base page may include, for example, an ACK bit for detecting an error. Accordingly, the exchange unit 801 may transmit a preset number of auto-negotiation messages to compare ACK bits included in the transmitted auto-negotiation messages. The exchange unit 801 may transmit an auto-negotiation message of the link establishing device 800 including a first ACK bit to the link partner device a preset number of times. The exchange unit 801 may receive an auto-negotiation message of the link partner device including the first ACK bit from the link partner device a preset number of times.

Subsequently, the exchange unit 801 may transmit an auto-negotiation message of the link establishing device 800 including a second ACK bit to the link partner device a preset number of times. The exchange unit 801 may receive an auto-negotiation message of the link partner device including the second ACK bit from the link partner device a preset number of times.

Accordingly, the exchange unit 801 may conduct a matching test of the auto-negotiation messages using the ACK bits included in the auto-negotiation messages of the link partner device and base page fields included in the auto-negotiation messages of the link partner device.

The base page fields may refer to a field storing the link information on the link partner device. In detail, the link establishing device 800 may conduct an M-stage matching test to secure reliability of the link information on the link partner device. For example, the exchange unit 801 may determine whether first ACK bits included in one or more auto-negotiation messages received from the link partner device are the same. Also, the exchange unit 801 may determine whether base page fields included in one or more auto-negotiation messages received from the link partner device are the same.

Furthermore, the exchange unit 801 may determine whether a base page field included in the auto-negotiation message of the link partner device including the first ACK bit is the same as a base page field included in the auto-negotiation message of the link partner device including the second ACK bit. In response, the link partner device may conduct a matching test of the auto-negotiation messages using the auto-negotiation messages transmitted by the exchange unit 801.

A priority order determination unit 802 may determine priority order of available links among a plurality of links connected between the link establishing device 800 and the link partner device using the link information on the link establishing device 800 and the link information on the link partner device.

For example, the priority order determination unit 802 may determine the priority order for link establishment using connection mode information on links included in the link information on the link establishing device 800 and the link information on the link partner device. Here, the connection mode information may include transmission speed information.

In detail, various connection modes for a link between the link establishing device 800 and the link partner device may be set up using the multi-core fiber. The link between the link establishing device 800 and the link partner device may provide various transmission speeds depending on connection modes. Accordingly, the priority order determination unit 802 may determine the priority order according to transmission speeds of the available links among the plurality of links connected between the link establishing device 800 and the link partner device using the transmission speed information included in the link information on the link establishing device 800 and the link information on the link partner device.

For example, the base page detected by the exchange unit 801 from the auto-negotiation message may include an AB bit with the transmission speed information on the links available to the link partner device input. Accordingly, the priority order determination unit 802 may determine the priority order using the transmission speed information input in the AB bit and transmission speed information on the available links of the link establishing device 800. Here, criteria for determining the priority order may be set up by a system administrator or a user. For example, the link establishing device 800 may determine the priority order of the available links in order of higher transmission speeds using the link information on the link establishing device 800 and the link information on the link partner device.

When the priority order is determined according to transmission speed, the priority order determination unit 802 may the priority order for link establishment using flow control information on links included in the link information on the link establishing device 800 and the link information on the link partner device. Here, flow control may refer to control of transmission and reception via a link. In detail, when a transmission speed of a link established between the link establishing device 800 and the link partner device is higher than a processing speed of the link establishing device 800 or link partner device, the link establishing device 800 and the link partner device may delete data received through the link. Thus, the priority order determination unit 802 may determine the priority order for flow control of links between the link establishing device 800 and the link partner device to control transmission and reception via the links, thus preventing deletion of data. Here, criteria for determining the priority order for the flow control may be set up by a system administrator or a user.

The link establishing device 800 may recognize error occurrence in a link using error information included in the link information received from the link partner device. On the contrary, the link partner device may recognize error occurrence in a link using error information included in the link information received from the link establishing device 800. For example, the base page detected by the exchange unit 801 from the auto-negotiation message may include an RF bit with input error information on the link establishing device 800. Accordingly, the link establishing device 800 may recognize the error information through the RF bit.

A link establishment unit 803 may establish a link based on the multi-core fiber between the link establishing device 800 and the link partner device according to the priority order. In response, the link partner device may recognize the link information on the link establishing device 800 through auto-negotiation message exchanges. The link partner device may determine priority order of available links among a plurality of links connected between the link establishing device 800 and the link partner device using the link information on the link establishing device 800 and the link information on the link partner device. Here, links established respectively by the link establishment unit 803 and the link partner device based on the respective priority orders may be the same. The link establishing device 800 and the link partner device may transmit and receive data through the same link.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, other implementations, alternative embodiments and equivalents to the claimed subject matter are construed as being within the appended claims.

What is claimed is:

1. A link establishing method performed by a link establishing device, the method comprising:
exchanging link information on the link establishing device and link information on a link partner device through auto-negotiation messages;
determining priority order of available links among a plurality of links connected between the link establishing device and the link partner device using the link information on the link establishing device and the link information on the link partner device; and
establishing a link based on a multi-core fiber between the link establishing device and the link partner device on the basis of the priority order.

2. The method of claim 1, wherein the determining of the priority order determines the priority order according to transmission speeds of the available links among the plurality of links connected between the link establishing device and the link partner device using transmission speed information on links comprised in the link information on the link establishing device and the link information on the link partner device.

3. The method of claim 2, wherein the determining of the priority order determines priority order for flow control using flow control information on links comprised in the link information on the link establishing device and the link information on the link partner device when the priority order is determined according to the transmission speeds.

4. The method of claim 1, wherein the exchanging of the link information comprises detecting a base page from an auto-negotiation message of the link partner device; and identifying the link information on the link partner device in the detected base page.

5. The method of claim 1, wherein the exchanging of the link information comprises transmitting an auto-negotiation message of the link establishing device comprising a first acknowledgement (ACK) bit a preset number of times from the link establishing device to the link partner device; receiving an auto-negotiation message of the link partner device comprising the first ACK bit from the link partner device a preset number of times; transmitting an auto-negotiation message of the link establishing device comprising a second ACK bit a preset number of times from the link establishing device to the link partner device in response to reception of the auto-negotiation message from the link partner device; and receiving an auto-negotiation message of the link partner device comprising the second ACK bit from the link partner device a preset number of times.

6. The method of claim 4, wherein the detecting comprises determining whether first ACK bits comprised in one or more auto-negotiation messages received from the link partner device are the same; determining whether base page fields comprised in the auto-negotiation messages of the link partner device comprising the first ACK bits are the same; and determining whether the base page fields comprised in the auto-negotiation messages of the link partner device comprising the first ACK bits are the same as base page fields comprised in auto-negotiation messages of the link partner device comprising second ACK bits.

7. The method of claim 1, wherein the exchanging of the link information comprises detecting a next page field comprised in an auto-negotiation message of the link partner device; and identifying information transmitted by at least one of the link partner device and a service in the detected next page field.

8. The method of claim 4, wherein the base page comprises at least one of connection mode information, flow control information, error information and acknowledgement information provided by the link partner device.

9. The method of claim 1, wherein the determining of the priority order determines the priority order of the available links among the plurality of links connected between the link establishing device and the link partner device using link information comprised in a base page in an auto-negotiation message of the link partner device and the link information on the link establishing device.

10. The method of claim 1, wherein the establishing of the link establishes a link between a first link establishing device and a second link establishing device by controlling the multi-core fiber according to the priority order.

11. A link establishing apparatus performing a link establishing method, the apparatus comprising:
an exchange unit to exchange link information on the link establishing device and link information on a link partner device through auto-negotiation messages;
a priority order determination unit to determine priority order of available links among a plurality of links connected between the link establishing device and the link partner device using the link information on the link establishing device and the link information on the link partner device; and
a link establishment unit to establish a link based on a multi-core fiber between the link establishing device and the link partner device on the basis of the priority order.

12. The apparatus of claim 11, wherein the priority order determination unit determines the priority order according to transmission speeds of the available links among the plurality of links connected between the link establishing device and the link partner device using transmission speed information on links comprised in the link information on the link establishing device and the link information on the link partner device.

13. The apparatus of claim 12, wherein the priority order determination unit determines priority order for flow control using flow control information on links comprised in the link information on the link establishing device and the link information on the link partner device when the priority order is determined according to the transmission speeds.

14. The apparatus of claim 11, wherein the exchange unit detects a base page from an auto-negotiation message of the link partner device and identifies the link information on the link partner device in the detected base page.

15. The apparatus of claim 11, wherein the exchange unit transmits an auto-negotiation message of the link establishing device comprising a first acknowledgement (ACK) bit a preset number of times from the link establishing device to the link partner device, receives an auto-negotiation message of the link partner device comprising the first ACK bit from the link partner device a preset number of times, transmits an auto-negotiation message of the link establishing device comprising a second ACK bit a preset number of times from the link establishing device to the link partner device in response to reception of the auto-negotiation message from the link partner device, and receives an auto-negotiation message of the link partner device comprising the second ACK bit from the link partner device a preset number of times.

16. The apparatus of claim 14, wherein the exchange unit determines whether first ACK bits comprised in one or more auto-negotiation messages received from the link partner device are the same, determines whether base page fields comprised in the auto-negotiation messages of the link partner device comprising the first ACK bits are the same, and determines whether the base page fields comprised in the auto-negotiation messages of the link partner device comprising the first ACK bits are the same as base page fields comprised in auto-negotiation messages of the link partner device comprising second ACK bits.

17. The apparatus of claim 11, wherein the exchange unit detects a next page field comprised in an auto-negotiation message of the link partner device, and identifies information transmitted by at least one of the link partner device and a service in the detected next page field.

18. The apparatus of claim 14, wherein the base page comprises at least one of connection mode information, flow control information, error information and acknowledgement information provided by the link partner device.

19. The apparatus of claim 11, wherein the priority order determination unit determines the priority order of the available links among the plurality of links connected between the link establishing device and the link partner device using link information comprised in a base page in an auto-negotiation message of the link partner device and the link information on the link establishing device.

20. The apparatus of claim 11, wherein the link establishment unit establishes a link between a first link establishing device and a second link establishing device by controlling the multi-core fiber according to the priority order.
